(19) United States
(12) Patent Application Publication
(10) Pub. No.: US 2004/0134995 A1
(43) Pub. Date: Jul. 15, 2004

(54) Vehicle windshield ice and snow melt system

(76) Inventor: Russell M. Keeler, Evergreen, CO (US)

Correspondence Address: RUSSELL M. KEELER, 2296 S. AUGUSTA DRIVE, EVERGREEN, CO, 80439, US

(21) Appl. No.: 10/342,836

(22) Filed: Jan. 15, 2003

(51) Int. Cl. B60S 1/58

(52) U.S. Cl. 237/12

(57) ABSTRACT

Until this time, the problem of ice and snow buildup on windshields has been dealt with using a technology that was developed to remove water from the exterior and condensation from the interior. Ice and frost removal from the outside of a windshield using the defrost system required an extensive warm-up period combined with the manual operation of an ice scraping device. This method is impractical when the vehicle is moving. Attempts to melt ice and snow on the rear window using electric resistance wires embedded in the glass work well, but cannot be used in front facing applications because of interference with vision caused by the wires. The forced hot air approach proposed in this invention allows the glass to remain clear, and aids the windshield wipers in removing the softened and/or melted snow, a job for which the wipers were designed.

### BACKGROUND OF INVENTION

The general field of endeavor to which this invention belongs is that of automotive vehicles.

Subject matter for this invention includes the windshield, windshield wiper and defrosting systems of the vehicle.

When snow has high moisture content, it tends to adhere to it. This property of snow can cause reduced vision for vehicle occupants due to accumulations of snow when windshield wipers push the moist snow to the edge of the wiper blade travel. The snow accumulates and does not slide off the windshield because there is insufficient heat transfer from the inside of the vehicle through the windshield glass to warm the exterior glass surface to the point where the snow will not adhere to the glass. Snow also accumulates in the windshield wiper well, further reducing the effectiveness of the windshield wiper blades.

Information used to develop this invention consist of a general working knowledge of heating and air conditioning, air flow using fans, ducts and terminal devices and heat transfer. The information and concepts used are generally listed in the publications of the American Society of Heating, Refrigerating and Air Conditioning Engineers, Inc. (ASHRAE), specifically in the ASHRAE Handbook.

Previous attempts to deal with the ice and snow accumulation problems listed above have focused on the design of interior defrosting and ice removal from the wiper blades. Interior defrosting is only successful when the vehicle is stationary, as air velocity created by vehicle movement quickly removes any heat from the exterior glass surface, defeating the interior defroster as a means to melt ice and snow when the vehicle is moving. Attempts to remove ice from the wiper blades using flexible covers to the wiper blades do not solve the problem of snow accumulation on the wiper well or at the edge of wiper blade travel.

### BRIEF SUMMARY OF THE INVENTION

The Vehicle Windshield Ice and Snow Melt System (VWIASMS) provides a source of hot air at the exterior base of the windshield to melt and/or prevent the accumulation of snow and ice at the end of the wiper blade travel, and in the wiper well.

The stream of hot air discharges through outlets located where the snow and ice is most likely to accumulate. This hot air, delivered a high velocity, is directed onto the accumulated snow from below, and is less likely to be temperature diluted by the cold air traveling over the hood of the vehicle. Resultant melt water is drained through the discharge air plenum down into the warm engine compartment, where it can drop under the vehicle. Some of the melt water will be carried off around the windshield by the wind velocity at the exterior of the vehicle.

The system is an improvement over the inadequate heat transfer through the windshield glass, as a much higher temperature is directed to the affected area. The system also improves performance of mechanical ice breakage attempted by so-called “winter” wipers. These wipers rely solely on mechanical action to break up ice.

### BRIEF DESCRIPTION OF DRAWINGS

FIG. 1 shows a typical vehicle with the engine compartment exposed to view. Major components within the engine compartment are shown, including major components of the VWISMS. The system consists of a fan coil system to heat the air, ductwork to deliver the hot air to the supply plenum, discharge grilles, piping, controls and electrical systems to provide power to operate the controls and fan.

FIG. 2 shows a section through the vehicle and engine compartment to further describe the components in their relative positions The locations and configuration of components are based on a sample vehicle. It is understood that the location of major components and routing of ductwork may vary depending on the design of the specific engine compartment of the vehicle.

### DETAILED DESCRIPTION OF THE INVENTION

The VWISMS is a hot water or electric resistance heat based fan coil system including fan, heating coil, air filter, duct system, control valve and piping, dampers, discharge grilles and associated controls. The system draws air from the engine compartment through a fan, heats the air and discharges the heated air through slots at the exterior base of the windshield at the windshield wiper well.

Although the detailed capacities will vary based on the size of the windshield, a generic version based on a compact car with a windshield length of five feet is described.

Operating Characteristics:

The air temperature at the wiper well discharge shall not exceed 105° F., to prevent skin burns. The supply air quantity shall be 3-4 cubic feet per minute (CFM) for a total flow of 150-200 CFM.

Air Intake:

Provide an air intake with disposable media filter, 30 percent efficiency with filter rack for filter replacement. The filter rack shall include wire hatch on no more than one-inch centers in both directions on both sides of the filter media or other means to maintain media positioning. The air intake shall be sized for no more than a 500 feet per minute (FPM) face velocity across the filter media. For the example given, the area of the intake shall be no less than 0.3 square feet, or approximately 6.5 inches by 7 inches.

Fan:

Supply fan shall be either centrifugal or squirrel cage type, 150-200 CFM, with direct drive fan motor, mounted on rubber vibration isolation mounts. Fan shall be sized for air quantity and external static pressure based on specific installation test, approximately 0.5 inches water gage. Fan intake connection shall be as required for type of fan selected. Connect intake to fan with flexible connection if hard connected to intake duct, or internally isolated if fan is mounted inside intake duct.

Heating Coil:

Provide heating coil with copper tubes and aluminum fins with a maximum fin spacing of 11 per inch. Coil may be one or two row, depending on fin spacing and test performance. Face velocity of coil shall not exceed 550 FPM. Coil shall include supply and return water connections and isolation valves. Supply and return water piping shall be of same material as radiator hose. Connect heating coil piping to operate in parallel with radiator. Provide modulating 2-way heating hot water control valve to modulate water flow in coil to maintain 105 F supply air temperature. Control sequence shall be initiated by activation of snowmelt discharge command at vehicle temperature control panel. For an air-cooled engine configuration, provide electric resistance heating coil with a minimum of two stages of control.

Supply Duct:

Duct may be constructed of galvanized sheet metal, aluminum or plastic, and may be rigid or flexible, round, oval, rectangular or square. Duct insulation with rigid exterior protection should be considered for durability. Duct air velocity shall not exceed 1500 feet per minute.

Supply Air Plenum:

Provide supply air plenum at windshield wiper well, and connect supply duct to plenum. Plenum shall include discharge openings at top, with 2-position dampers and electric damper actuators. Discharge openings shall be no more than 1 inch by 12 inches. Provide weep holes for water drainage.

Discharge Grilles:

Grilles shall be mounted on top of wiper well at an angle that allows the air to flow parallel to the angle of the windshield. Provide vertical bars on 1-inch centers within the discharge opening.

Control Sequence:

The VWISMS shall be initiated by operation of a selector switch on the vehicle instrument panel. This selection will enable the controls of the system. At the start signal, the control system shall be energized, the fan shall run, the hot water control valve shall open, and the discharge dampers shall open. The control valve shall remain open until the air temperature in the supply duct reaches the set point, at which point the control valve shall modulate to maintain set point. When the system is deactivated, the reverse sequence shall take place.

1: What I claim as my invention is the use of ducted hot air introduced to the exterior of the vehicle adjacent to the windshield and windshield wiper well in the general areas where ice and snow accumulate as a method to melt and remove the accumulated snow and ice.

2: What I claim as my invention is that continued operation of the ice and snow melt system will keep additional ice and snow from accumulating in these areas.

3: What I claim as my invention is the use of radiator coolant as the source of heat to the fan coil system used to heat the air that is used in the melt process.

4: What I claim as my invention is the use of a plenum and air discharge arrangement at the base of the windshield at the general area of the windshield wiper well.

5: What I claim as my invention is the use of a hot water coil in a duct system to generate the hot air.

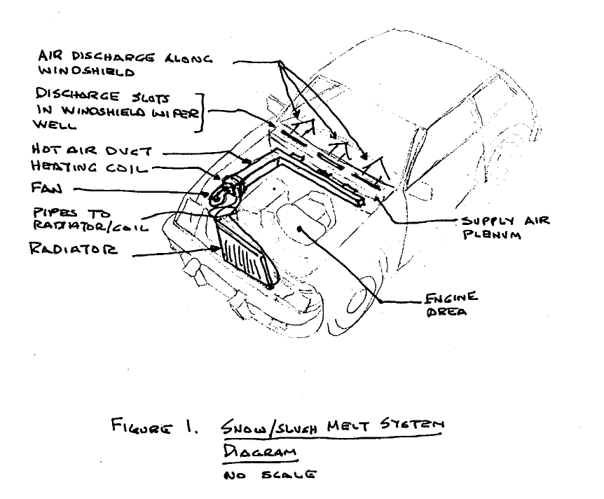

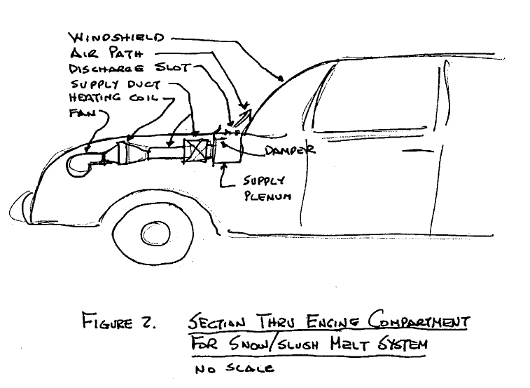

6: What I claim as my invention is the general configuration of the ice and snow melt system as shown in FIGS. 1 and 2.

7: What I claim as my invention is the sequence of operation for the system, as described in “Detailed Description of the Invention”.
